(19) United States
(12) Patent Application Publication
(10) Pub. No.: US 2004/0177042 A1
(43) Pub. Date: Sep. 9, 2004

(54) Digital rights management for end-user content

(75) Inventor: Gideon Fostick, Givat Shmuel (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE NETWORK SYSTEMS, LTD.

(21) Appl. No.: 10/378,909

(22) Filed: Mar. 5, 2003

(51) Int. Cl. G06F 17/60

(52) U.S. Cl. 705/51

(57) ABSTRACT

Rights in unmarked end user provide content are protected by receiving a message comprising content, obtaining a unique identifier, and comparing the unique identifier to a database of known identifiers if a known unique identifier is found, the message is delivered, if allowed according to the distribution rights authorized by the content provider. If known unique identifier is found, the unique identifier is found, the unique identifier is stored in the content repository, and the message is delivered. Further forwarding of the contents is thus authorized only when indicated in the authorized distribution rights.

### BACKGROUND OF THE INVENTION

The invention relates generally to the field of digital rights management, and more specifically to a method and apparatus for enabling digital rights management for end-user created content.

Digital rights management (DRM) enables the control of digital content to ensure that content providers are compensated for the legitimate use of their digital content. Prior art DRM systems are focused on the content provider publishing the information and as part of the publishing process marking the content so as to control distribution. The marking is accomplished by encrypting or sealing the content in some manner that cannot be removed, so as to ensure that only authorized users can gain access. While such a method may be suitable for the distribution of movies and books, it is not ideally suited for the individual user who wishes to create and control content.

Short Messaging Services (SMS) or text messaging, has become very popular for cellular telephones, with the number of text messages being sent in certain countries outstripping the amount of cellular telephone calls being made. SMS content such as logos, ringing tones and news alerts have become quite popular, and are a significant source of revenue for many operators. In order to prevent the user from forwarding the SMS content to another user, forward locking is implemented on the SMS content, so that the user is unable to forward the message. Such forward locking constitutes the DRM of the SMS content.

Multimedia Messaging Services (MMS) is an extension to SMS which includes such content as color images, animated characters, video, sounds, sound bites and other premium content. MMS does not currently support forward locking. Because MMS does not support forward locking, the consumer can forward the message and content without further payment to the content provider. Such a further distribution ability circumvents the requirement for the consumer to compensate content providers. Enabling forward locking, however, might not be the best answer. Forward locking prevents any content redistribution. Content creators might benefit by a controlled redistribution of content, in which each additional user is charged a licensing fee. Such a controlled redistribution could represent a possible additional revenue stream to the content creator.

Valuable, protectable content is produced not only by so-called content creators, but also by end users. Such end users have the ability to generate valuable content, such as digital images, sound bites and other multimedia content, and these end users may desire to control distribution of their content. Forward locking does not provide an ideal DRM solution for such end users who create content. Currently there are only very limited means of enabling the individual end user to restrict the distribution of a multimedia message, or to track and collect royalties on the further distribution of their created content.

One prior art system requires the end user to install dedicated software before they can access marked content. The dedicated software handles all communication with a license server to retrieve appropriate licenses to access sealed content on behalf of an authenticated end user. Such a requirement to install additional dedicated software at the end user prior to being able to access the marked content adds an additional burden to the user and is not appropriate in some situations, for example for controlling content being sent to a cellular telephone. In one prior art system the dedicated software enables the user to create and mark content, but again such software must be purchased by the end user. Additionally, it is not applicable to MMS content being created by a cellular end user since, commonly, cellular phones do not have the means to install and run such software.

Other prior art systems enable controlling the distribution of marked MMS messages, by tracking the mark, thus enabling billing for the redistribution of the marked content. Unfortunately they do not enable controlling the distribution of, or charging for, content created by an individual end user, which is not inherently marked by the content creator. A mark embedded by the creator would need to be automatically recognized by the system, and additionally should preferably also be unobtrusive and not interfere with the content. Cellular telephones are not equipped with the capability to perform such marking.

Thus there is a need for a method and apparatus that will allow an end-user to send unmarked messages with content whose further distribution can be restricted by the end-user.

### SUMMARY OF THE INVENTION

Accordingly, it is a principal object of the present invention to overcome the disadvantages of prior art methods of digital rights management. This is provided in an embodiment of the present invention by receiving a message comprising content; scanning the content to obtain a unique identifier and comparing the unique identifier with a database of known unique identifiers; if the unique identifier does not match any unique identifiers found in the database, storing the unique identifier in the database and delivering the message to a delivery address; if the unique identifier does match an unique identifier found in the database, retrieving distribution rights associated with the stored unique identifier, examining the distribution rights, and, if delivery is allowed, delivering the message in accordance with the distribution rights.

In one embodiment, the known unique identifiers comprise one or more of an MD5 signature of the content, a CRC signature of the content, a low resolution image of the content and a pre-determined unique watermark of the content. In another embodiment, the invention further comprises the stage of marking the content with a watermark. In yet another embodiment the invention further comprises the stage of generating a billing record for the message.

In an exemplary embodiment, the message further comprises a requester field indicating a level of requested distribution rights. In one further embodiment the method further comprises the stage of storing the requested distribution rights on the database, with the distribution rights being associated with the unique identifier. In another further embodiment the requester field comprises a keyword in the message. In one still further embodiment, the keyword is in a predetermined location in the message, the predetermined location being either in the header, the subject, the beginning or the end of the message. In another still further embodiment the invention further comprises the stage of stripping the requester field from the message.

In one exemplary embodiment the content is text messaging content, in another exemplary embodiment the content comprises color images, animated characters, video or sound, and in yet another exemplary embodiment the message is an e-mail message.

The invention also provides for an apparatus, for restricted distribution of content generated by an end-user, comprising a content transfer system and a content repository connected with the content transfer system; the content transfer system comprising scanning functionality for scanning content of a message to obtain a unique identifier; comparison functionality for comparing the unique identifier with a database of known unique identifiers stored on the content repository; storing functionality for storing a unique identifier not found on the database of known unique identifiers in the database, retrieving functionality for retrieving the distribution rights associated with a known unique identifier, examining functionality for examining the retrieved distribution rights and authorizing delivery in accordance with those rights, and delivery functionality for delivering the message to a delivery address.

In one embodiment the known unique identifiers comprise one or more of an MD5 signature of the content, a CRC signature of the content, a low resolution image of the content and a pre-determined unique watermark in the content. In another embodiment the content transfer system further comprises marking functionality for marking the content with a watermark.

In yet another embodiment the content transfer system further comprises generating functionality for generating a billing record for the content of the message.

In an exemplary embodiment, the message comprises a requester field indicating a level of distribution rights. In one further embodiment the storage functionality is utilized to store the indicated distribution rights on the database, the indicated distribution rights being associated with the unique identifier. In another further embodiment the requester field comprises a keyword in the message. In a still further embodiment the keyword is in a predetermined location in the message, the predetermined location being either in the header, the subject, the beginning or the end of the message. In another still further embodiment the content transfer system further comprises message modifying functionality for stripping the requester field from the message.

In one exemplary embodiment the content is text messaging content, in another exemplary embodiment the content comprises images, animated characters, video or sound, and in yet another exemplary embodiment the message is an e-mail message.

An embodiment of the invention also provides for a system for restricted distribution, of content generated by an end-user, comprising an end-user terminal, a communication link connected to the end-user terminal, a content transfer system connected to the communication link and a content repository connected with the content transfer system; the content transfer system comprising receiving functionality for receiving a message sent from the end-user terminal through the communication link, scanning functionality for scanning content of a message to obtain a unique identifier; comparison functionality for comparing the unique identifier with a database of known unique identifiers stored on the content repository; storing functionality for storing a unique identifier not found on the database of known unique identifiers in the database, retrieving functionality for retrieving the distribution rights associated with a known unique identifier, examining functionality for examining the retrieved distribution rights and authorizing delivery in accordance with those rights, and delivery functionality for delivering the message to a delivery address.

In one embodiment the known unique identifiers comprise one or more of an MD5 signature of the content, a CRC signature of the content, a low resolution image of the content and a pre-determined unique watermark in the content. In another embodiment the content transfer system further comprises marking functionality for marking the content with a watermark.

In yet another embodiment the content transfer system further comprises generating functionality for generating a billing record for the content of the message.

In an exemplary embodiment, the message comprises a requester field indicating a level of distribution rights. In one further embodiment the storage functionality is utilized to store the indicated distribution rights on the database, the indicated distribution rights being associated with the unique identifier. In another further embodiment the requester field comprises a keyword in the message. In a still further embodiment the keyword is in a predetermined location in the message, the predetermined location being either in the header, the subject, the beginning or the end of the message. In another still further embodiment the content transfer system further comprises message modifying functionality for stripping the requester field from the message.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level block diagram of a digital rights management system according to a generalized embodiment of the present invention;

FIG. 2 illustrates a high level block diagram of an embodiment of the control transfer system of FIG. 1;

FIG. 3 illustrates a high level flow chart used to restrict distribution rights according to a first embodiment of the present invention;

FIG. 4 illustrates a high level flow chart used to restrict distribution rights according to a second embodiment of the present invention;

FIG. 5 illustrates a high level functional block diagram of an embodiment of the content transfer system of FIG. 1; and

FIG. 6 illustrates a high level functional block diagram of a message sending client.

### DETAILED DESCRIPTION OF THE PREFERRED EMBODIMENTS

The present embodiments enable the end-user to restrict the distribution rights of unmarked content of a message.

Before explaining at least one embodiment of the invention in detail, it is to be understood that the invention is not limited in its application to the details of construction and the arrangement of the components set forth in the following description or illustrated in the drawings. The invention is applicable to other embodiments and capable of being practiced or carried out in various ways. Also, it is to be understood that the phraseology and terminology employed herein is for the purpose of description and should not be regarded as limiting.

In particular, the invention will be described in relation to an MMS cellular system, however this is not meant to be limiting in any way. The invention can, for example, be applied to an e-mail service comprising a central server. The only requirement is that messages produced by an end-user must pass through a server prior to arriving at their end destination. For the purposes of this description, marked content is defined as content that has information embedded within it in a manner that is not easily removable by an end-user, so as to enable a system to ensure that only authorized users can gain access to the content.

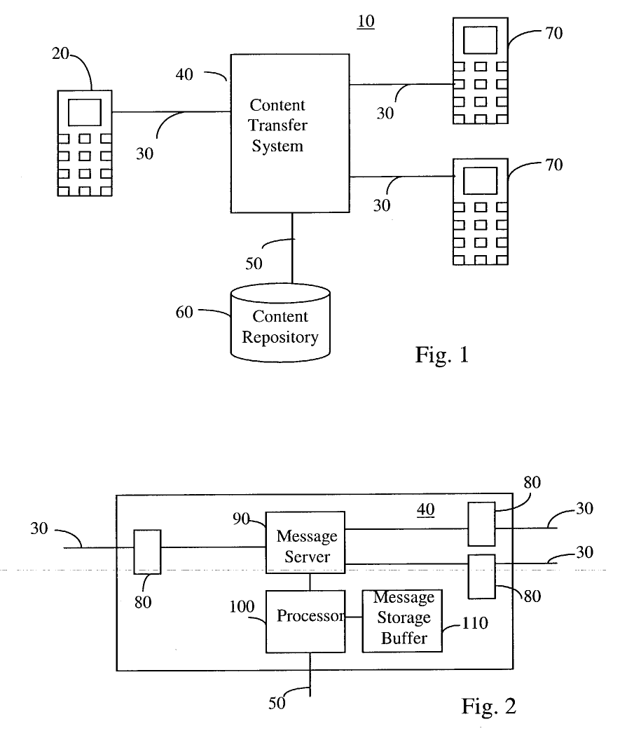

FIG. 1 is a high-level block diagram of an MMS system 10 incorporating digital rights management according to a first embodiment of the invention. The system 10 comprises an originating end-user terminal 20, communication links 30, a content transfer system 40, a data connection 50, a content repository 60 and recipient end-user terminals 70. Originating end-user terminal 20 is connected by communication link 30 to one port of content transfer system 40 and recipient end-user terminals 70 are each connected over one of the communication links 30 to another port of content transfer system 40. Content repository 60 is connected by data connection 50 to content transfer system 40. Only two recipient end-user terminals 70 are shown for simplicity, however it is to be understood that the number of end-user terminals will typically be much larger. Similarly, content transfer system 40 may comprise a single unit or a network of multiple units.

In operation, unmarked content is sent within a message from originating end-user terminal 20 over communication link 30 and received by content transfer system 40. The message includes a destination address, which identifies one or more destination end-user terminals 70, and optionally a request indicator, hereinafter the “requester field” (for linguistic convenience only), to be described further herein, indicating the level of protection desired. In one embodiment the unmarked content is SMS content, while in another embodiment the unmarked content is an image, sound bite, or multi-media part of an e-mail message. In an exemplary embodiment the unmarked content is an image, sound bite or multi-media content of an MMS message. Communication link 30 may comprise a wireless data link, or a data connection such as an Internet or Intranet connection. Content transfer system 40 receives the message, checks for the existence of the optional requester field and, if found, strips the requester field from the message. Content transfer system 40 then checks the content of the message by comparing certain unique features identifying the message with data stored in content repository 60, as will be described further below. Data describing the contents distribution rights is stored in content repository 60 associated with the unique identifying features. In the event the unique identifying features are not found in repository 60, the submitter of the content is henceforward regarded as the creator, and distribution rights as requested by the creator, in a manner to be further described below, will be stored in repository 60 associated with the unique identifying features. The content is then forwarded to its destination address, i.e. one or more end-user terminals 70. Optionally, content transfer system 40 adds a watermark to the content prior to delivery, thus identifying the content to users as marked. In the event the unique identifying features are found in repository 60, the content will only be forwarded in accordance with the contents distribution rights associated with the unique identifying features.

FIG. 2 is a high-level block diagram of the content transfer system 40 of FIG. 1, according to an exemplary embodiment of the invention. The content transfer system 40 comprises one end of communication links 30, communication link handlers 80, message server 90, processor 100 and message storage buffer 110. One end of each communication link 30 is connected to a link handler 80, and each link handler 80 is connected to message server 90. Processor 100 is connected to message storage buffer 110 and to data connection 50 for ultimate connection to content repository 60 (not shown). Each link handler 80 may handle multiple communication links 30.

In operation, link handler 80 controls the physical layer of communication over communication link 30, and messages received over communication link 30 are sent to message server 90. Processor 100 controls the flow of messages in message server 90 and temporarily stores the message in message storage buffer 110. Processor 100 operates, as will be described further below, to scan the message in order to identify if its content is authorized for further distribution.

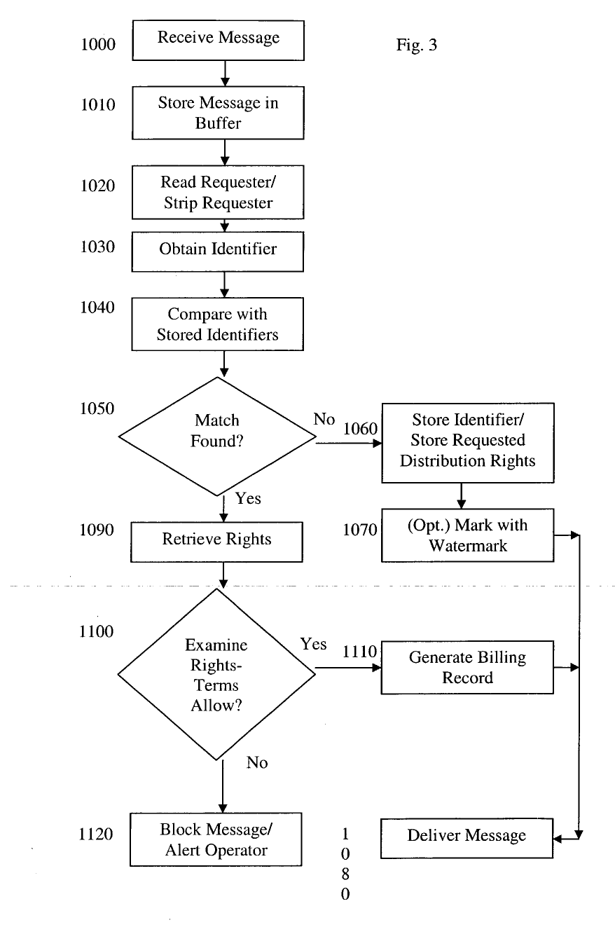

FIG. 3 is a high-level flow chart of the operational stages of restricting distribution rights according to a first embodiment of the invention. In stage 1000 content transfer system 40 receives a message comprising unmarked content whose distribution rights are to be restricted.

In stage 1010 the message is stored in message buffer 110. In stage 1020 the requester field that indicates the distribution terms desired by the content creator is read and stripped from the message. The requester field may be set to indicate valuable contents for which, e.g., (1) all users are to be charged, (2) only users to which the message is subsequently forwarded are to be charged, or (3) no forwarding is allowed. Optionally an amount or level of charges is specified.

In one embodiment the requested distribution terms are indicated by using a keyword in the subject of the message as the requester field. In another embodiment the format of the message allows for a dedicated header comprising a requester field that is set to the appropriate value. In yet another embodiment the format of the message allows for a dedicated header, and a keyword is used in the dedicated header to indicate the distribution terms. In yet another embodiment no header or subject is allowed, and a keyword is located in a pre-determined location in the message, such as a leading or trailing word. In yet another embodiment an unusual character string is used as the keyword, and placement in the message is unrestricted.

In stage 1030 processor 100 obtains a unique identifier of the content. In an exemplary embodiment the MD5 algorithm is used on the content of all messages and outputs a unique 128-bit content digest of the content of each message. In another embodiment all video content passing through the system is marked by the system with a pre-determined watermark by utilizing image processing thus indicating to users that the content is marked, and the video content is scanned to identify the presence of the pre-existing watermark. If the pre-determined watermark is found, it is output as the unique identifier. If no watermark is found, a null field is generated. In another embodiment, for all images, a low resolution image is generated to be utilized as a unique identifier. Any combination of the above methods, or other methods known to those skilled in the art, such as utilizing a CRC algorithm may be utilized to generate a unique identifier of the content without exceeding the scope of the invention.

In stage 1040 content repository 60 is searched for a matching unique identifier. In stage 1050 the search results are examined to see if a match was found.

If no match is found, in stage 1060 the unique identifier generated for the content is stored in content repository 60. The requested distribution rights as identified by the requester field are stored in content repository 60 and associated with the unique identifier. In stage 1070, in the optional embodiment in which a watermark is applied to all video content, a watermark is embedded in the content for ease of identification. The watermark also serves to notify the viewer that the content is now marked. In stage 1080 the message, comprising the content, is delivered to its intended destination, end-user terminal 70.

If a match is found in stage 1050, then in stage 1090 the distribution terms associated with the unique identifier are retrieved. In stage 1100 the distribution terms associated with the unique identifier found in the contents are examined and a delivery rights determination is made). If the distribution terms allow for transfer of the content, then in stage 1110 a billing record according to the terms is generated, and in stage 1080 the message is delivered to its intended destination, end-user terminal 70. If the terms do not allow for transfer, in stage 1120 the message is blocked, and optionally an error message is returned to the sender, and/or a system operator is alerted. Thus, the message delivery is handled in accordance with the delivery rights determination. Optionally, the content transfer system maintains a record of messages sent containing a match, and the system operator can generate a forensic analysis of the attempted misuse of the content, for example to identify repeat offenders.

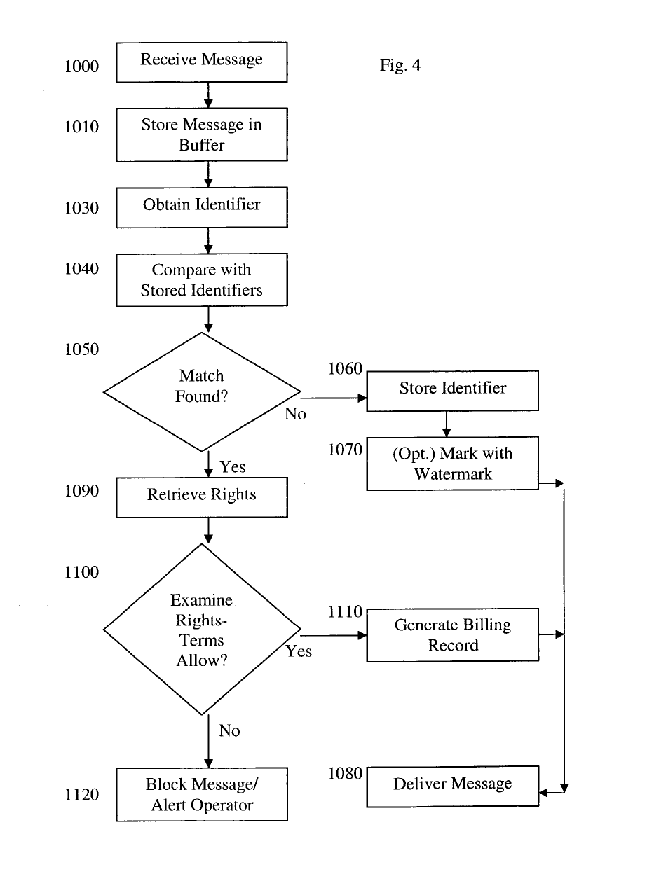

FIG. 4 is a high-level flow chart of the operational stages of restricting distribution rights according to a second embodiment of the invention. The operation of the second embodiment is similar to that of the first embodiment, except that the terms of distribution rights are set globally for all content generated by a given user. In one embodiment only certain content, such as images or video, are set to restricted distribution. In a further embodiment the licensing fees for use of the image or video are fixed in advance. In stage 1000 content transfer system 40 receives a message comprising unmarked content whose distribution rights are to be restricted. In an exemplary embodiment the unmarked content is an image, sound bite or other multi-media content of an MMS message. In another embodiment the content is SMS content, while in yet another embodiment the content is an image, sound bite or other multi-media content attachment to an e-mail message.

In stage 1010 the message is stored in message storage buffer 110. In stage 1030 processor 90 obtains a unique identifier of the content. In an exemplary embodiment the MD5 algorithm is used on the content of all messages and outputs a unique 128 bit content digest of the content. In another embodiment all video content passing through the system is marked by the system with a unique pre-determined watermark in a pre-determined location and format, and the content is therefore scanned to identify the presence of a pre-existing watermark. The watermark serves the additional purpose of advising the user that the content has been marked. If the unique watermark is found, it is output as the unique identifier. If no watermark is found, a null field is generated. In another embodiment, for all images a low-resolution image is generated to be utilized as a unique identifier. Any combination of the above methods, or other methods known to those skilled in the art, such as utilizing a CRC algorithm, may be utilized to generate a unique identifier for the content without exceeding the scope of the invention.

In stage 1040, content repository 60 is searched for a matching unique identifier. In stage 1050 the search results are examined to see if a match was found.

If no match is found, in stage 1060 the unique identifier is stored in content repository 60. The requested distribution rights are also stored in content repository 60, and are associated with the unique identifier. In stage 1070, in the optional embodiment in which a watermark is applied to all video content, a watermark is embedded in the content as a unique identifier. The watermark also serves to notify the viewer that the content is now marked. In stage 1080 the message, comprising the content is delivered to its original destination, end-user terminal 70.

If a match is found in stage 1050, then in stage 1090 the distribution terms associated with the content are retrieved. In a preferred embodiment the globally set distribution terms are stored in a single location unless special terms have been set for this content. In stage 1100 the terms associated with the contents are examined. If the terms allow for transfer of the content, then in stage 1110 a billing record according to the terms is generated, and in stage 1080 the message is delivered to its original destination, end-user terminal 70. If the terms do not allow for transfer, in stage 1120 the message is blocked, and optionally a system operator is alerted. Optionally, the content transfer system maintains a record of messages sent containing a match, and the system operator can generate a forensic analysis of the misuse of the content, for example to identify repeat offenders.

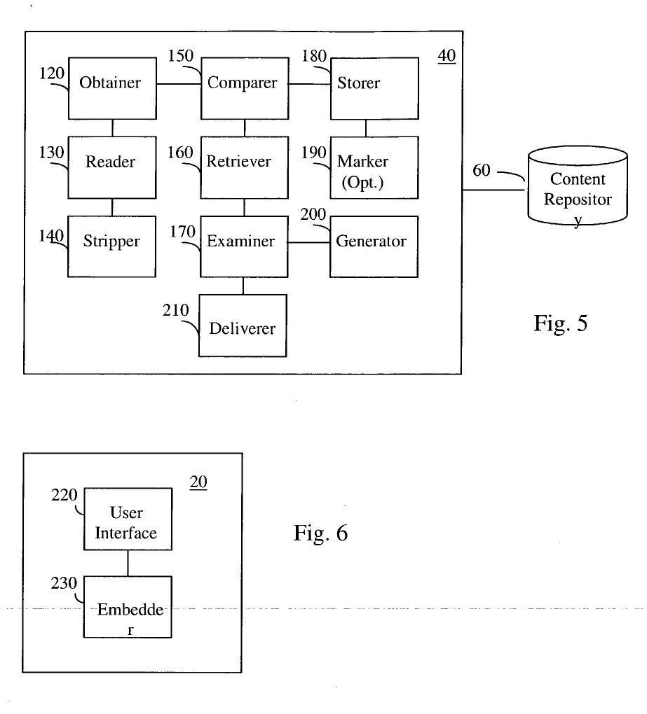

FIG. 5 illustrates a high level functional block diagram for helping to explain the operation of content transfer system 40. Content transfer system 40 comprises obtainer 120, reader 130, stripper 140, comparer 150, retriever 160, examiner 170, storer 180, optional marker 190, generator 200 and deliverer 210. Connection 50 and content repository 60 are shown for clarity. Obtainer 120 is associated with comparer 150, identifier 130 and stripper 140. Comparer 150 is further associated with retriever 160 and storer 180. Retriever 160 is further associated with examiner 170, and examiner 170 is associated with generator 200 and deliverer 210. Content transfer system 40 is connection by data connection 50 to content repository 60.

In operation, content sent by an end-user is received by content transfer system 40, and obtainer 120 obtains a unique identifier from the content of the message. In an exemplary embodiment, the end-user has embedded a requester field in the message in a manner described above in relation for FIG. 3, and reader 130 reads the requester field in the message. Stripper 140 associated with identifier 130 subsequently strips the requester field from the message.

Comparer 150 associated with obtainer 120 compares the unique identifier obtained by obtainer 120 with a database of known unique identifiers stored on content repository 60 through data connection 50. Storer 180 associated with comparer 150 stores a unique identifier not found in the known database, storing it on content repository 60 through data connection 50. In an embodiment in which all video content is marked with a watermark, optional marker 190 associated with storer 180 marks the content with a unique watermark for ease of identification and as indication to a recipient that the content has restricted distribution rights.

Retriever 160 associated with comparer 150 retrieves distribution rights associated with content whose unique identifier is found in the database of known identifiers. Examiner 170 associated with retriever 160 examines the distribution rights to determine if delivery of the content is authorized. Generator 200, associated with examiner 170, generates a billing record in accordance with the distribution rights associated with the content of the message. Deliverer 210 associated with generator 200 delivers the message to its indented destination in accordance with the distribution rights.

FIG. 6 illustrates a high-level functional block diagram for a message sending client, operative as part of originating end-user terminal 20, comprising user interface 220 and embedder 230. User interface 220 allows the user to define requested distribution rights for user generated content and, in an exemplary embodiment, comprises plug-in type software for a communication module. The requested distribution rights may optionally indicate that all users are to be charged, that only users to which the message is subsequently forwarded are to be charged, or that no forwarding is allowed. Optionally an amount or level of charges is specified.

Embedder 230 associated with user interface 220 embeds the requested distribution rights within the message, in a manner that can be read by the content transfer system 40. In one embodiment the requested distribution rights are embedded as a keyword in the subject of the message. In another embodiment the requested distribution rights are embedded by embedder 230 in a dedicated header. In yet another embodiment embedder 230 embeds the requested distribution rights as a keyword located in a pre-determined location in the message, such as a leading or trailing word. In yet another embodiment embedder 230 embeds the requested distribution rights as an unusual character string placed in the message.

It is appreciated that certain features of the invention which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather, the scope of the present invention is defined by the appended claims, and includes both combinations and subcombinations of the various features described hereinabove as well as variations and modifications thereof which would occur to persons skilled in the art upon reading the foregoing description.

I claim:

1. A method of managing rights of end-user generated content, comprising:
receiving a message comprising unmarked content;
obtaining a unique identifier based on said unmarked content;
comparing said unique identifier with a database of known unique identifiers associated with available distribution rights;
when said unique identifier does not match any of said known unique identifiers stored in said database,
(i) storing said unique identifier in said database, and
(ii) delivering said message to a delivery address;
when said unique identifier does match one of said known unique identifiers in said database,
(i) retrieving said available distribution rights associated with said matched known unique identifier,
(ii) making a delivery rights determination, based on said available distribution rights, as to whether delivery is allowed, and
(iii) performing the delivery of said message, to a delivery address, in accordance with said distribution rights determination.

2. The method of claim 1, wherein said known unique identifiers comprise one or more of an MD5 signature of said content, a CRC signature of said content, a low resolution image of said content, and a known unique watermark in said content.

3. The method of claim 1, further comprising marking said content with a pre-determined watermark to identify that the content is marked.

4. The method of claim 1, further comprising using said retrieved distribution rights to generate a billing record for said unmarked content.

5. The method of claim 1, further comprising reading a requester field in said message, indicating a level of desired distribution rights for said unmarked content.

6. The method of claim 5, wherein said storing of said unique identifier in said database further comprises storing in said database said requested distribution rights in association with said unique identifier.

7. The method of claim 5, wherein said requester field comprises a keyword located within said message.

8. The method of claim 7, wherein said keyword is at a predetermined location in said message.

9. The method of claim 8, wherein said predetermined location is chosen from the group consisting of a header field, a subject field, a beginning, and an end of said message.

10. The method of claim 5, further comprising stripping said requester field from said message prior to delivering said message to said address.

11. The method of claim 1, wherein said content is text messaging content.

12. The method of claim 1, wherein said content is multimedia content.

13. The method of claim 12, wherein said multimedia content is at least one of images, animated characters, video and sound.

14. The method of claim 1, wherein said message is an e-mail message.

15. An apparatus, for restricted distribution of unmarked content generated by an end-user, comprising:
a content transfer system; and
a content repository connected with said content transfer system;
said content transfer system comprising:
signature obtaining functionality, for obtaining a unique identifier of content of a message;
comparison functionality, associated with said signature obtaining functionality, for comparing said unique identifier with a database of known unique identifiers stored in said content repository and associated with available distribution rights;
storing functionality, associated with said comparison functionality, for storing in said database a unique identifier not found in said database of known unique identifiers;
retrieving functionality, associated with said comparison functionality, for using a successful comparison result to retrieve distribution rights associated with a known unique identifier in said database;
examining functionality, associated with said retrieving functionality, for authorizing delivery of said message according to said retrieved distribution rights; and
delivery functionality, associated with said examining functionality, for carrying out or blocking delivery of said message in accordance with said distribution rights.

16. The apparatus of claim 15, wherein said known unique identifiers comprise one or more of an MD5 signature of said content, a CRC signature of said content, a low resolution image of said content, and a pre-determined watermark in said content.

17. The apparatus of claim 15, wherein said content transfer system further comprises marking functionality, associated with said storing functionality, for marking said content with a pre-determined watermark so as to identify that said content has distribution rights stored in said content repository.

18. The apparatus of claim 15, wherein said content transfer system further comprises generating functionality, associated with said examining functionality, for generating a billing record according to said distribution rights for said message.

19. The apparatus of claim 15, wherein said content transfer system further comprises reading functionality, associated with said obtaining functionality, for reading in said message a requester field indicating a level of desired distribution rights.

20. The apparatus of claim 19, wherein said storing functionality also stores said requested distribution rights in association with said unique identifier on said database.

21. The apparatus of claim 19, wherein said requester field comprises a keyword located in said message.

22. The apparatus of claim 21, wherein said reading-functionality is operable to read said keyword at a predetermined location in said message.

23. The apparatus of claim 22, wherein said predetermined location is chosen from the group consisting of the header, the subject, the beginning, and the end of said message.

24. The apparatus of claim 19, wherein said content transfer system further comprises stripping functionality for stripping said requester field from said message prior to delivery.

25. The apparatus of claim 15, wherein said content is text messaging content.

26. The apparatus of claim 15, wherein said content comprises images, animated characters, video, or sound.

27. The apparatus of claim 15, wherein said message is an e-mail message.

28. An end user message sending client, for sending messages having content, comprising:
a user interface for allowing a user to define distribution rights for said content,
an embedder, associated with said user interface, for readably embedding within said message an indicator, of said user requested distribution rights.
